(19) United States
(12) Patent Application Publication
(10) Pub. No.: US 2026/0301612 A1
(43) Pub. Date: Oct. 1, 2026

(54) DISPLAY PANEL FOR SAFETY FENCE

(71) Applicant: DONGWOO FINE-CHEM CO., LTD., Iksan-si (KR)

(72) Inventors: Young Min LEE, Iksan-si (KR); Yongun Hwang, Iksan-si (KR); Daewoong Park, Iksan-si (KR)

(73) Assignee: DONGWOO FINE-CHEM CO., LTD., Iksan-si (KR)

(21) Appl. No.: 19/437,481

(22) Filed: Dec. 31, 2025

(30) Foreign Application Priority Data
Mar. 28, 2025 (KR) 10-2025-0040630

(51) Int. Cl. G09F 19/22; G09F 13/22

(52) U.S. Cl. CPC G09F 19/228; G09F 13/22; G09F 2013/222

(57) ABSTRACT

A display panel for a safety fence comprises a light-emitting part rear cover made of a transparent material, a light-emitting part coupled to the front of the light-emitting part rear cover, and a light-emitting part front cover coupled to the front of the light-emitting part and made of a transparent material.

### CROSS REFERENCE TO RELATED APPLICATIONS

This application claims priority based on Korean Patent Application No. 10-2025-0040630, filed Mar. 28, 2025, the entire content of which is incorporated herein by reference in its entirety.

### TECHNICAL FIELD

The present invention relates to a safety fence for school zones. Particularly, the present invention relates to a display panel for a safety fence that enables drivers or pedestrians to intuitively recognize traffic signal conditions through the display panel of the safety fence, thereby preventing traffic accidents in school zones.

### BACKGROUND ART

Safety fences (guard rails) are installed on roads to ensure pedestrian safety. Safety fences are placed between the roadway and the sidewalk to prevent vehicles from crashing onto the sidewalk. Additionally, safety fences block pedestrians from jaywalking onto the roadway, preventing traffic accidents. Safety fences are installed where the roadway and sidewalk meet. Safety fences are typically positioned 30 to 100 cm from the boundary line between the sidewalk and roadway, toward the sidewalk side.

Safety fences comprise support pillars spaced at regular intervals, support frames connecting the top and bottom of the support pillars, barrier panels attached inside the support frames, and the like.

However, while safety fences are mandatory in areas frequented by children, such as elementary schools, relying solely on their installation is insufficient to guarantee children's safety due to factors like distractions or playful behavior.

### DISCLOSURE

### Technical Problem

The present invention aims to address these shortcomings of the prior art.

An object of the present invention is to fundamentally prevent or minimize traffic accidents caused by driver or child inattention or error by enabling children and drivers in school zones to visually and distinctly recognize the current traffic signal status from all directions.

Another object of the present invention is to prevent or minimize damage or loss/degradation of the functionality of the internal devices of the safety fence, particularly the light-emitting parts (e.g., LED panels) or functional layers (e.g., diffusion plates), caused by children's mischief or similar actions within school zones.

Yet another object of the present invention is to prevent or minimize the inflow of foreign substances or light scattering.

Still another object of the present invention is to enable drivers or pedestrians to easily recognize the situation on the opposite side.

### Technical Solution

To achieve these objects, a display panel for a safety fence of the present invention comprises a light-emitting part rear cover, a light-emitting part, a light-emitting part front cover, and the like.

The light-emitting part rear cover is made of a transparent material.

The light-emitting part is coupled to the front of the light-emitting part rear cover and lights up a sign of a specific shape (e.g., a traffic sign).

The light-emitting part front cover is coupled to the front of the light-emitting part and made of a transparent material.

The display panel for a safety fence of the present invention further comprises a fence cover coupled to the front of the light-emitting part front cover and made of a transparent material.

The display panel for a safety fence of the present invention further comprises a functional layer coupled between the front of the light-emitting part front cover and the rear of the fence cover.

In the display panel for a safety fence of the present invention, the functional layer may be a diffuser plate having the same shape as a light-emitting shape of the light-emitting part.

In the display panel for a safety fence of the present invention, the light-emitting part comprises a substrate, metal wiring formed on the substrate, a solder resist sealing upper and side portions of the metal wiring while forming an opening on its upper side, and a light-emitting device coupled to the opening of the solder resist.

The display panel for a safety fence of the present invention further comprises a light-emitting part shock absorber. The light-emitting part shock absorber is coupled between the light-emitting part and the light-emitting part rear cover and configured to absorb shock applied to the light-emitting part.

In the display panel for a safety fence of the present invention, the light-emitting part shock absorber may be a damping tape coupled along a rear edge of the light-emitting part.

The display panel for a safety fence of the present invention further comprises a light-emitting part protective layer. The light-emitting part protective layer fills the space between the light-emitting part front cover and the light-emitting part rear cover while encapsulating the light-emitting part.

In the display panel for a safety fence of the present invention, the light-emitting part protective layer is made of an optically clear resin (OCR).

The display panel for a safety fence of the present invention further comprises a lateral sealing part. The lateral sealing part is coupled along a rear edge of the light-emitting part front cover and a front edge of the light-emitting part rear cover while separating the light-emitting part front cover and the light-emitting part rear cover and sealing the light-emitting part protective layer to be embedded.

The display panel for a safety fence of the present invention further comprises a functional layer protective part. The functional layer protective part is coupled between a rear surface of the functional layer and a front surface of the light-emitting part front cover and between a front surface of the functional layer and a rear surface of the fence cover.

In the display panel for a safety fence of the present invention, the functional layer protective part is configured so that the functional layer protective part coupled between the rear surface of the functional layer and the front surface of the light-emitting part front cover is coupled along a rear edge of the functional layer.

In the display panel for a safety fence of the present invention, the functional layer protective part is configured to be coupled along a lateral outer surface of the functional layer between the front surface of the light-emitting part front cover and the rear surface of the fence cover.

In the display panel for a safety fence of the present invention, the functional layer protective part is configured to be coupled along a boundary of a rear edge of the lateral outer surface of the functional layer and the front surface of the light-emitting part front cover.

The display panel for a safety fence of the present invention comprises a support frame, a functional layer support, a functional layer protective part, and the like.

The support frame is spaced apart from a lateral edge of the functional layer.

The functional layer support connects the support frame and a lateral edge of the functional layer.

The functional layer protective part is configured to be coupled along an outer surface of the functional layer support between the support frame and the lateral edge of the functional layer.

In the display panel for a safety fence of the present invention, the functional layer protective part is coupled along a boundary of the functional layer support and the support frame.

In the display panel for a safety fence of the present invention, the functional layer protective part is composed of an adhesive.

In the display panel for a safety fence of the present invention, the functional layer is configured to have a width larger than the light-emitting part.

### Advantageous Effects

According to the present invention, having this configuration, the current traffic signal, that is, the signal status for vehicle proceeding and vehicle stop, is visually displayed continuously across the entire area of the safety fence installed along the road in a school zone. Through this, the present invention enables children and drivers in the school zone to visually recognize the current traffic signal status from all directions. As a result, it can fundamentally prevent or minimize traffic accidents caused by driver or child inattention or error.

The present invention uses shock-absorbing means, namely a light-emitting part shock absorber and a light-emitting part protective layer, to protect the light-emitting part displaying the traffic signal status from external impacts (e.g., child tampering), and further uses a functional layer protective part. Through this, the invention can significantly enhance the durability of the safety fence by preventing or minimizing damage or functional degradation of the display part, which is the core component of the safety fence display panel.

The present invention can prevent foreign substances such as insects and dust from entering the functional layer area by sealing the periphery of the functional layer with a functional layer protective part. This minimizes light scattering while preventing the functional layer from deteriorating, providing visual comfort to drivers and pedestrians.

Furthermore, by making the area excluding the light-emitting part transparent, drivers and pedestrians can easily perceive the situation on the opposite side, providing high visibility.

### DESCRIPTION OF DRAWINGS

FIGS. 1a and 1b illustrate safety fence display panels according to the present invention installed along a road in a school zone.

FIG. 1c illustrates a system linking a safety fence display panel according to the present invention to a school zone traffic signal system.

FIG. 2 shows a front view and a cross-sectional view of a safety fence display panel according to the present invention.

FIGS. 3a and 3b are cross-sectional views illustrating a first embodiment for protecting a functional layer in a safety fence display panel according to the present invention and a modified example thereof, respectively.

FIGS. 4a and 4b are cross-sectional views illustrating a second embodiment for protecting a functional layer in a safety fence display panel according to the present invention and a modified example thereof, respectively.

FIGS. 5a and 5b are perspective views illustrating a third embodiment for protecting a functional layer in a safety fence display panel according to the present invention and a modified example thereof, respectively.

### BEST MODE

Hereinafter, the present invention will be described in more detail with reference to the accompanying drawings.

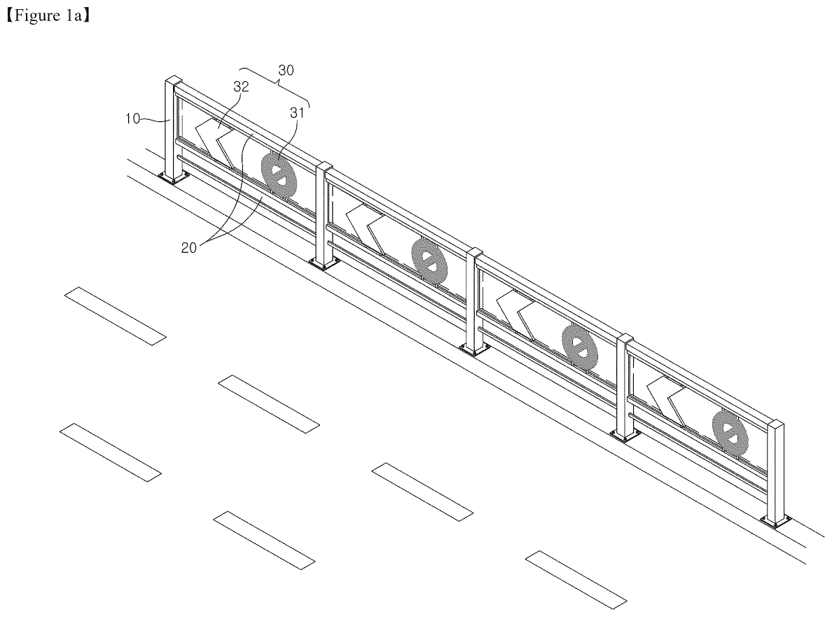

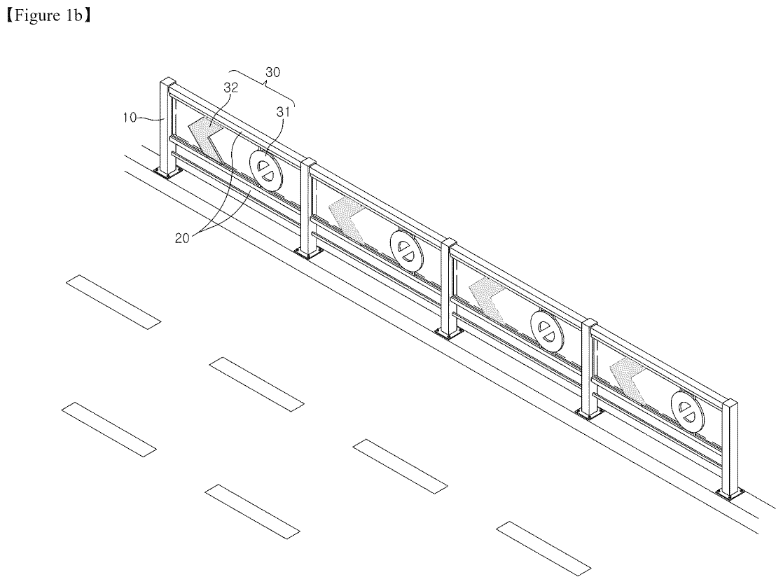

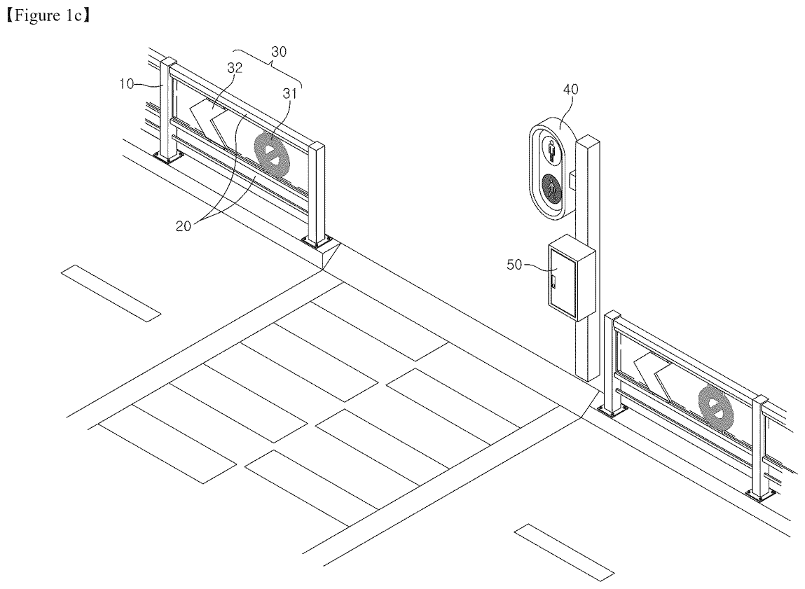

FIGS. 1a and 1b illustrate safety fence display panels according to the present invention installed along a road in a school zone.

As shown in FIGS. 1a and 1b, the school zone safety fence is a protective facility that separates the roadway from the sidewalk in a school zone to ensure the safety of children walking on the sidewalk. The present invention relates to a safety fence display panel, which is a component of the safety fence, configured to display the traffic signal status in the school zone.

The school zone safety fence may include a support pillar 10, a support frame 20, a display part 30, and the like.

The support pillar 10 supports the support frame 20. A plurality of support pillars 10 may be arranged at regular intervals along the boundary between the roadway and the sidewalk.

The support pillar 10 may be configured as a bar having a cross-section such as a square or a circle.

The support pillar 10 can be made of materials such as plastic or metal.

The support frame 20 supports the display part 30. The support frames 20 can be vertically spaced and coupled between adjacent support pillars 10.

The support frame 20 may be configured as a bar having a cross-section such as a square or a circle. The support frame 20 may form a void space, as shown in FIGS. 1a and 1b, between the top and bottom of the support pillar 10 into which the display part 30 is embedded and coupled.

The support frame 20 may incorporate an illumination controller (not shown) for driving the display part 30. The illumination controller may be a PCB, etc.

The support frame 20 can be made of materials such as plastic or metal.

The display part 30 indicates vehicle proceeding/stop. The display part 30 may include a plurality of display sections such as a first display section 31 and a second display section 32. The first display section 31 may be a sign indicating ‘Vehicles Stop’, as shown in FIG. 1a. The second display section 32 may be a sign indicating ‘Vehicles Proceed’, as shown in FIG. 1b.

The display part 30 can illuminate and emit light for the corresponding sign based on power and control signals received from the illumination controller (not shown).

FIG. 1c illustrates a system linking a safety fence display panel according to the present invention to a school zone traffic signal system.

As shown in FIG. 1c, the safety fence display panel of the present invention can be operated in conjunction with the school zone traffic signal system. The school zone is equipped with a crosswalk, a traffic signal 40, and a traffic signal controller 50. The safety fence display panel of the present invention can be linked to the traffic signal controller 50.

For example, when the traffic signal controller 50 signals a pedestrian crossing signal, i.e., ‘Vehicles Stop’, as shown in FIG. 1c, the safety fence can activate the first display section 31 to illuminate a sign indicating ‘Vehicles Stop’.

On the other hand, when the traffic signal controller 50 signals ‘Vehicles Proceed’, as shown in FIG. 1b, the safety fence can activate the second display section 32 to illuminate a sign indicating ‘Vehicles Proceed’.

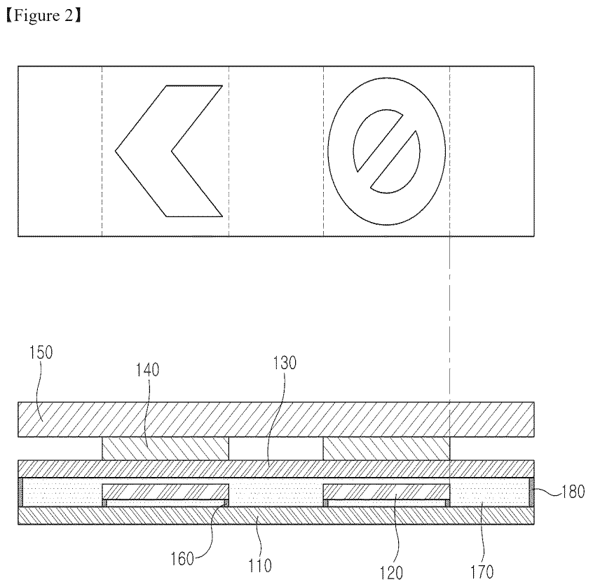

FIG. 2 shows a front view and a cross-sectional view of a safety fence display panel according to the present invention.

As shown in FIG. 2, the safety fence display panel of the present invention may comprise a light-emitting part rear cover 110, a light-emitting part 120, a light-emitting part front cover 130, a functional layer 140, a fence cover 150, a light-emitting part shock absorber 160, a light-emitting part protective layer 170, a lateral sealing part 180, a functional layer protective part 190, and the like.

The light-emitting part rear cover 110 supports the light-emitting part 120. The light-emitting part rear cover 110 can be coupled to the rear of the light-emitting part 120. The light-emitting part rear cover 110 can be composed of a transparent material, such as glass or transparent plastic. As the transparent plastics, polyester, polystyrene, polyamide, polyetherimide, polyacrylic, polyimide, polyethersulfone, polysulfone, polyethylene, polypropylene, polymethyl pentene, polyvinyl chloride, polyvinylidene chloride, polyvinyl alcohol, polyvinyl acetal, polyether ketone, polyether ether ketone, polyether sulfone, polymethyl methacrylate, polyethylene terephthalate, polybutylene terephthalate, polyethylene naphthalate, polycarbonate, polyurethane, epoxy, etc. can be used.

The light-emitting part 120 emits light of a specific shape. The light-emitting part 120 can be coupled and fixed to the front of the light-emitting part rear cover 110.

The light-emitting part 120 may include a substrate, metal wiring, solder resist, light-emitting devices, etc.

As the substrate, transparent materials such as glass or plastic may be used. As the transparent plastics, ethylene vinyl acetate copolymer, polyester, polystyrene, polyamide, polyetherimide, polyacrylic, polyimide, polyethersulfone, polysulfone, polyethylene, polypropylene, polymethyl pentene, polyvinyl chloride, polyvinylidene chloride, polyvinyl alcohol, polyvinyl acetal, polyether ketone, polyether ether ketone, polyether sulfone, polymethyl methacrylate, polyethylene terephthalate, polybutylene terephthalate, polyethylene naphthalate, polycarbonate, polyurethane, epoxy, etc. can be used.

The metal wiring supplies power to the light-emitting devices. The metal wiring can be formed on the substrate. The metal wiring can be composed of conductive metals such as copper (Cu), aluminum (Al), nickel (Ni), chromium (Cr), silver (Ag), iron (Fe), gold (Au), cobalt (Co), titanium (Ti), tungsten (W), etc. The metal wiring can be formed using a metal thin film process, such as electroplating, electroless plating, sputtering, thermal evaporation, e-beam evaporation, or the like.

The solder resist mounts and supports the light-emitting devices. The solder resist may be configured to form an opening on its upper surface for mounting a light-emitting device while sealing a portion of the top and sides of the metal wiring. The solder resist may be composed of a photosensitive resin composition, etc.

The solder resist can arrange the openings where the light-emitting devices are mounted into patterns such as a ‘Vehicles Stop’ indicator or a ‘Vehicles Proceed’ indicator.

The light-emitting devices emit light. The light-emitting devices can be inserted into the openings in the solder resist to be connected with the metal wiring. A plurality of light-emitting devices can be arranged identically to the arrangement pattern of the openings in the solder resist to emit light as indicators such as ‘Vehicles Stop’ or ‘Vehicles Proceed’. The light-emitting devices can be LEDs, etc.

The light-emitting part front cover 130 protects the light-emitting part 120. The light-emitting part front cover 130 can be attached to the front of the light-emitting part 120. The light-emitting part front cover 130 can be made of a transparent material capable of transmitting light, such as glass or transparent plastic. As the transparent plastics, polyester, polystyrene, polyamide, polyetherimide, polyacrylic, polyimide, polyethersulfone, polysulfone, polyethylene, polypropylene, polymethyl pentene, polyvinyl chloride, polyvinylidene chloride, polyvinyl alcohol, polyvinyl acetal, polyether ketone, polyether ether ketone, polyether sulfone, polymethyl methacrylate, polyethylene terephthalate, polybutylene terephthalate, polyethylene naphthalate, polycarbonate, polyurethane, epoxy, etc. can be used.

The functional layer 140 is a translucent component that diffuses light emitted from the light-emitting part 120 to ensure uniform color and brightness across the entire screen. The functional layer 140 can be coupled to the front of the light-emitting part front cover 130.

The functional layer 140 may be configured to have the same shape as the light-emitting shape of the light-emitting part 120. For example, if the light-emitting part 120 is arranged in a sign shape indicating ‘Vehicles Stop’, the functional layer 140 may similarly be configured in a sign shape indicating ‘Vehicles Stop’. If the light-emitting part 120 is arranged in a sign shape indicating ‘Vehicles Proceed’, the functional layer 140 can similarly be configured in a sign shape indicating ‘Vehicles Proceed’.

The functional layer 140 may be a diffuser plate, diffuser film, light-modulating layer, light-modulating film, light-attenuating layer, light-attenuating film, or the like. The diffuser plate may be composed of acrylic resin, etc.

The fence cover 150 protects the functional layer 140, the light-emitting part front cover 130, and other components positioned at the rear. The fence cover 150 can be coupled to the front of the functional layer 140.

The fence cover 150 may be composed of a transparent material that transmits light and possesses durability, such as transparent plastic. As the transparent plastics, polyester, polystyrene, polyamide, polyetherimide, polyacrylic, polyimide, polyethersulfone, polysulfone, polyethylene, polypropylene, polymethyl pentene, polyvinyl chloride, polyvinylidene chloride, polyvinyl alcohol, polyvinyl acetal, polyether ketone, polyether ether ketone, polyether sulfone, polymethyl methacrylate, polyethylene terephthalate, polybutylene terephthalate, polyethylene naphthalate, polycarbonate, polyurethane, epoxy, etc. can be used.

The light-emitting part shock absorber 160 protects the light-emitting part 120 from impact. The light-emitting part shock absorber 160 can be coupled between the light-emitting part 120 and the light-emitting part rear cover 110.

The light-emitting part shock absorber 160 may be composed of a shock-absorbing material such as sponge. For example, the light-emitting part shock absorber 160 may be a damping tape bonded (adhered) along the rear edge of the light-emitting part 120. The damping tape may be a double-sided adhesive tape simultaneously adhered to the rear surface of the light-emitting part 120 and the front surface of the light-emitting part rear cover 110.

The light-emitting part protective layer 170 protects the light-emitting part 120. The light-emitting protective layer 170 may be configured to fill the space between the light-emitting part front cover 130 and the light-emitting part rear cover 110, thereby encapsulating the light-emitting part 120.

The light-emitting part protective layer 170 may be composed of an optically clear resin (OCR).

When the light-emitting part front cover 130 and the light-emitting part rear cover 110 are spaced apart and the light-emitting part protective layer 170 is filled in between, the lateral sealing part 180 is coupled along the edges of the light-emitting part front cover 130 and the light-emitting part rear cover 110, maintaining the separation between the light-emitting part front cover 130 and the light-emitting part rear cover 110 while maintaining the filling of the light-emitting part protective layer 170. The lateral sealing part 180 may be formed to seal the lateral ends of the light-emitting part front cover 130 and the light-emitting part rear cover 110 by bonding along the rear edge of the light-emitting part front cover 130 and the front edge of the light-emitting part rear cover 110.

The lateral sealing part 180 may use a sealing material such as silicone.

When the fence cover 150 and the light-emitting part front cover 130 are spaced apart and coupled while having the functional layer 140 embedded in between, the support frame 20 can embed and support the top/bottom and side ends of the fence cover 150 and the light-emitting part front cover 130.

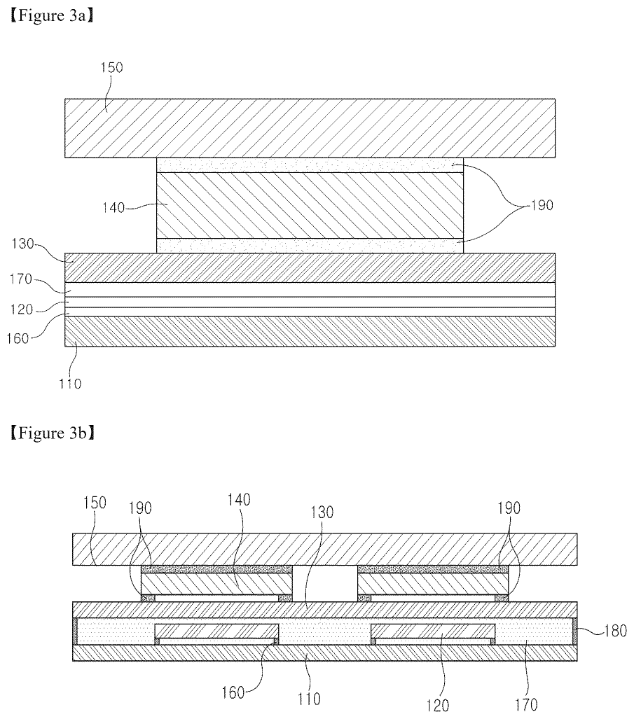

FIGS. 3a and 3b are cross-sectional views illustrating a first embodiment for protecting a functional layer in a safety fence display panel according to the present invention and a modified example thereof, respectively.

The functional layer protective part 190 protects the functional layer 140 from external impacts or blocks the inflow of foreign substances such as insects into the front or rear of the functional layer 140. As shown in FIG. 3a, the functional layer protective part 190 can be coupled while sealing between the rear surface of the functional layer 140 and the front surface of the light-emitting part front cover 130, and between the front surface of the functional layer 140 and the rear surface of the fence cover 150.

In another configuration, as shown in FIG. 3b, the functional layer protective part 190 may be formed to be coupled along the rear edge of the functional layer 140 between the functional layer 140 and the light-emitting part front cover 130, differing from FIG. 3a, while the functional layer protective part 190 is formed to entirely seal between the front surface of the functional layer 140 and the rear surface of the fence cover 150 between the functional layer 140 and the fence cover 150 in a manner identical to FIG. 3a. In this case, if the functional layer 140 is formed to have a width larger than the light-emitting part 120, the functional layer protective part 190 coupled along the rear edge of the functional layer 140 minimizes light leakage from the light-emitting part 120 to the outer sides of the functional layer 140, thereby enhancing the light-emitting efficiency of the light-emitting part 120. When enlarging the functional layer 140, forming it to be larger in the horizontal direction than the pitch size of the light-emitting device may be advantageous for minimizing light scattering.

In FIGS. 3a and 3b, the functional layer protective part 190 may be composed of an adhesive or an adhesive sheet. Meanwhile, the functional layer protective part 190, which is coupled along the rear edge of the functional layer 140 to enhance the light-emitting efficiency of the light-emitting part 120, may also be composed of a sealing member such as silicone.

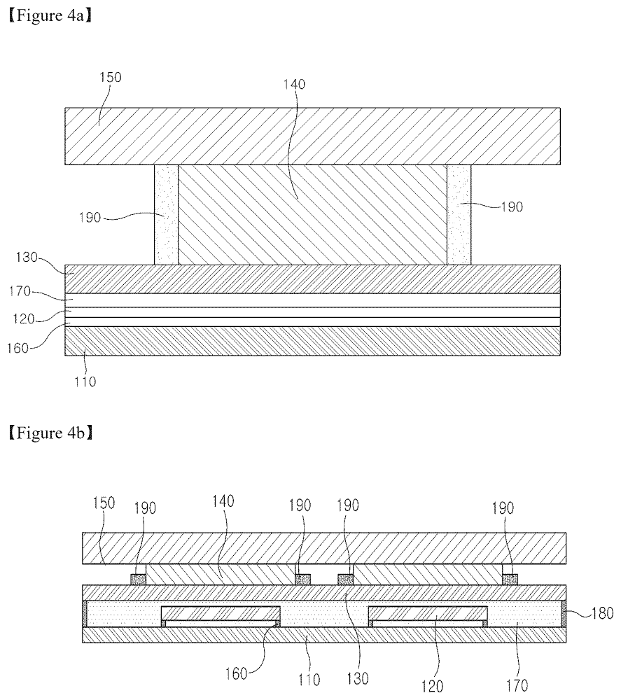

FIGS. 4a and 4b are cross-sectional views illustrating a second embodiment for protecting a functional layer in a safety fence display panel according to the present invention and a modified example thereof, respectively.

As shown in FIG. 4a, the functional layer protective part 190 may be formed to have a uniform thickness along the lateral outer surface of the functional layer 140 between the light-emitting part front cover 130 and the fence cover 150. In this case, the functional layer protective part 190 may extend to the front surface of the light-emitting part front cover 130 and the rear surface of the fence cover 150, thereby sealing the space between the functional layer 140 and the light-emitting part front cover 130 and the space between the functional layer 140 and the fence cover 150.

Alternatively, as shown in FIG. 4b, the functional layer protective part 190 may be formed to be coupled along the boundary between the rear edge of the lateral outer surface of the functional layer 140 and the front surface of the light-emitting part front cover 130. In this case, if the functional layer 140 is formed to have a width larger than the light-emitting part 120, the functional layer protective part 190 formed along the rear edge of the functional layer 140 minimizes light leakage from the light-emitting part 120 to the sides of the functional layer 140, thereby enhancing the light-emitting efficiency of the light-emitting part 120. Here, the functional layer protective part 190 coupled along the rear edge of the functional layer 140 may have a wedge shape (triangular cross-section) with an inclined open surface, and the inclined open surface may have a concave shape, if it possesses fluidity.

In FIG. 4b, the functional layer protective part 190 may be additionally formed along the boundary between the front edge of the lateral outer surface of the functional layer 140 and the rear surface of the fence cover 150. This allows sealing between the functional layer 140 and the fence cover 150, thereby blocking the inflow of foreign substances into the functional layer 140.

In FIGS. 4a and 4b, the functional layer protective part 190 may be composed of an adhesive or an adhesive sheet. The functional layer protective part 190, formed along the rear end of the lateral outer surface of the functional layer 140 to enhance the light-emitting efficiency of the light-emitting part 120, may also be composed of a sealing member such as silicone.

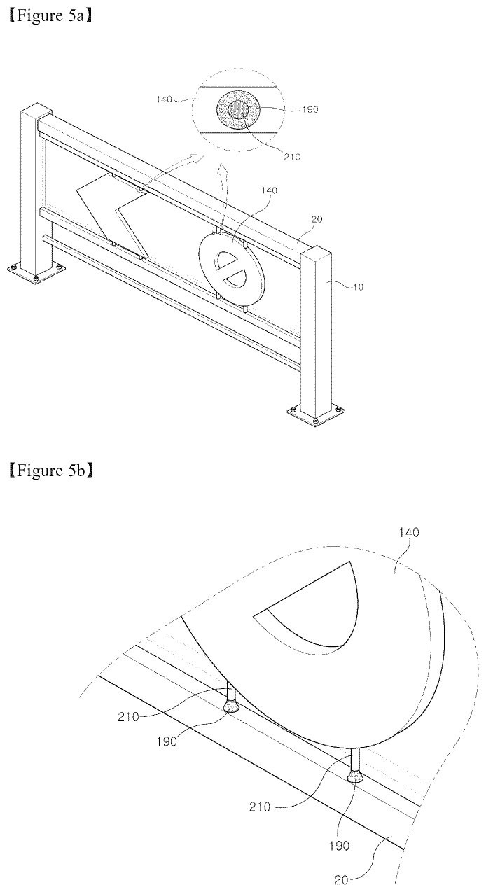

FIGS. 5a and 5b are perspective views illustrating a third embodiment for protecting a functional layer in a safety fence display panel according to the present invention and a modified example thereof, respectively.

As shown in FIG. 5a, the safety fence display panel of the present invention may include a support frame 20, a functional layer 140, a functional layer support 210, a functional layer protective part 190, and the like.

The support frame 20 may be spaced apart from the lateral edge of the functional layer 140 while supporting the functional layer 140 in a central direction.

The functional layer support 210 may connect the support frame 20 to the lateral edge of the functional layer 140, thereby fixedly supporting the functional layer 140 to the support frame 20. The functional layer support 210 may be configured as a bar.

The functional layer protective part 190 may be formed to have a uniform thickness along the outer surface of the functional layer support 210 between the support frame 20 and the lateral edge of the functional layer 140. The functional layer protective part 190 may also be formed at the boundary of the functional layer 140 and the functional layer support 210, and at the boundary of the support frame 20 and the functional layer support 210. Through this configuration, the functional layer protective part 190 can absorb external impacts applied to the functional layer 140, thereby preventing damage to the functional layer 140.

The functional layer protective part 190 may be composed of a sealing member such as silicone, in addition to an adhesive or adhesive sheet.

In another configuration, as shown in FIG. 5b, the functional layer protective part 190 may be formed to combine the boundary of the functional layer support 210 and the support frame 20. In this case as well, it can absorb impacts applied to the support frame 20, substantially blocking the transmission of impact to the functional layer 140 via the functional layer support 210.

In FIG. 5b, the functional layer protective part 190 may also be formed at the boundary of the functional layer support 210 and the functional layer 140. In this case, external impacts transmitted through the support frame 20 can further be blocked.

Although particular embodiments of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

### Description of Reference Numerals

10: support pillar
20: support frame
30: display part
31: first display section
32: second display section
110: light-emitting part rear cover
120: light-emitting part
130: light-emitting part front cover
140: functional layer
150: fence cover
160: light-emitting part shock absorber
170: light-emitting part protective layer
180: lateral sealing part
190: functional layer protective part
210: functional layer support

1. A display panel for a safety fence comprising:
a light-emitting part rear cover made of a transparent material;
a light-emitting part coupled to the front of the light-emitting part rear cover; and
a light-emitting part front cover coupled to the front of the light-emitting part and made of a transparent material.

2. The display panel for a safety fence according to claim 1, further comprising:
a fence cover coupled to the front of the light-emitting part front cover and made of a transparent material.

3. The display panel for a safety fence according to claim 2, further comprising:
a functional layer coupled between the front of the light-emitting part front cover and the rear of the fence cover.

4. The display panel for a safety fence according to claim 3, wherein the functional layer is a diffuser plate having the same shape as a light-emitting shape of the light-emitting part.

5. The display panel for a safety fence according to claim 1, wherein the light-emitting part comprises:
a substrate;
metal wiring formed on the substrate;
a solder resist sealing upper and side portions of the metal wiring while forming an opening on its upper side; and
a light-emitting device coupled to the opening of the solder resist.

6. The display panel for a safety fence according to claim 1, further comprising:
a light-emitting part shock absorber coupled between the light-emitting part and the light-emitting part rear cover and configured to absorb shock applied to the light-emitting part.

7. The display panel for a safety fence according to claim 6, wherein the light-emitting part shock absorber is a damping tape coupled along a rear edge of the light-emitting part.

8. The display panel for a safety fence according to claim 1, further comprising:
a light-emitting part protective layer filling the space between the light-emitting part front cover and the light-emitting part rear cover and encapsulating the light-emitting part.

9. The display panel for a safety fence according to claim 8, wherein the light-emitting part protective layer is made of an optically clear resin.

10. The display panel for a safety fence according to claim 8, further comprising:
a lateral sealing part coupled along a rear edge of the light-emitting part front cover and a front edge of the light-emitting part rear cover while separating the light-emitting part front cover and the light-emitting part rear cover and sealing the light-emitting part protective layer to be embedded.

11. The display panel for a safety fence according to claim 3, further comprising:
a functional layer protective part coupled between a rear surface of the functional layer and a front surface of the light-emitting part front cover and between a front surface of the functional layer and a rear surface of the fence cover.

12. The display panel for a safety fence according to claim 11, wherein the functional layer protective part is coupled along a rear edge of the functional layer between the rear surface of the functional layer and the front surface of the light-emitting part front cover.

13. The display panel for a safety fence according to claim 3, further comprising:
a functional layer protective part coupled along a lateral outer surface of the functional layer between a front surface of the light-emitting part front cover and a rear surface of the fence cover.

14. The display panel for a safety fence according to claim 13, wherein the functional layer protective part is coupled along a boundary of a rear edge of the lateral outer surface of the functional layer and the front surface of the light-emitting part front cover.

15. The display panel for a safety fence according to claim 3, further comprising:
a support frame spaced apart from a lateral edge of the functional layer;
a functional layer support connecting the support frame and a lateral edge of the functional layer; and
a functional layer protective part coupled along a lateral outer surface of the functional layer support between the support frame and the lateral edge of the functional layer.

16. The display panel for a safety fence according to claim 15, wherein the functional layer protective part is coupled along a boundary of the functional layer support and the support frame.

17. The display panel for a safety fence according to claim 11, wherein the functional layer protective part is composed of an adhesive.

18. The display panel for a safety fence according to claim 11, wherein the functional layer has a width larger than the light-emitting part.
